(19) United States
(12) Patent Application Publication
(10) Pub. No.: US 2005/0010950 A1
(43) Pub. Date: Jan. 13, 2005

(54) System and method for automatically generating a composite video-on-demand content

(76) Inventors: John Carney, Corte Madera, CA (US); Greg Thomson, Mill Valley, CA (US); David de Andrade, San Anselmo, CA (US); Matt Marenghi, San Francisco, CA (US); Samuel Moreau, Mill Valley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/763,580

(22) Filed: Jan. 23, 2004

Related U.S. Application Data
(60) Provisional application No. 60/486,570, filed on Jul. 11, 2003.

(51) Int. Cl. H04N 5/445; H04N 7/173

(52) U.S. Cl. 725/45; 725/61; 725/86; 725/87

(57) ABSTRACT

Embodiments of the invention provide systems and methods for the automatic creation, and subsequent presentation as a passive viewing experience, of a composite VOD clip created based upon one or more specified VOD clip categories. For one embodiment, a user selects one or more VOD clip categories from a list or other selection presentation and a composite VOD clip is created having component VOD clips that are constrained by the selected VOD clip categories. For one embodiment of the invention, the user may also select one or more VOD clip parameters for each of the selected VOD clip categories that further constrain the content of the composite VOD clip. Embodiments of the invention thereby provide for the automatic creation of a VOD composite clip having component VOD clips constrained by selected categories or selected categories and parameters that can be presented as a passive viewing experience.

### CLAIM OF PRIORITY

This application claims the benefit of U.S. Provisional Patent Application No. 60/486,570, entitled “Personalized News and Entertainment Programs”, which was filed Jul, 11, 2003.

### RELATED APPLICATIONS

This application is related to U.S. Patent Application No. ______, entitled “System and Method for Creating and Presenting Composite Video-on-Demand Content,” filed on Dec. 3, 2003, and U.S. patent application Ser. No. 10/390,064, entitled “System and Method for Construction, Delivery and Display of iTV, which was filed on Mar. 14, 2003, both of which are incorporated herein by reference.

1. Field

The invention relates to presentation of video information and more specifically to systems and methods for the automatic generation of composite video-on-demand (VOD) content.

2. Background

Interactive television (iTV) provides a user with many additional ways of interacting with a television other than the conventional interaction of adjusting volume, changing channels, and presenting video recordings. For example, using iTV, a user can select and present (i.e. play) video content delivered over a network. This capability, generally known as VOD programming, is currently available, in varying forms, to millions of digital cable users. VOD programming typically includes any programming that allows users to select and present video content over a network. Typically, a user may select the start time, and then further, generally, has the ability to support VCR-like controls such as fast-forward, fast-rewind, and pause. Using VOD programming, users are provided with many options, such as browsing and selecting a VOD program, selecting a package of VOD programs that the user may present individually, or selecting a VOD package (e.g., a set of VOD programs), the contents of which vary over time, but allows the user unrestricted access for the time period of the subscription.

With the current advancements in digital set top box application capabilities, cable system operators may also provide newer interfaces for the selection and playback of VOD programming. Typically, such VOD programming is generally focused on feature length programming, but recently has come to encompass shorter length programming and advertisements. Some of this shorter length programming includes small clips from MPEG or IP based streaming systems, and also includes clips that may be pre-recorded, by the system operator, to a user's hard drive. Further, these video clips that reside on the local hard disk, or within the system operators streaming equipment, have metadata associated with them that describe such data elements as title, category and sub categories.

However, current solutions for managing the extensive VOD content titles available to the user are limited to user selection and management of sets of ‘favorites’ or ‘selected titles’, which the user can subsequently access and wherefrom select individual titles to play. Prior art systems do not allow for the dynamic creation and presentation of user-specified VOD content consisting of multiple VOD clips as a passive viewing experience.

### BRIEF DESCRIPTION OF THE DRAWINGS

The invention may be best understood by referring to the following description and accompanying drawings that are used to illustrate embodiments of the invention. In the drawings:

FIG. 1 illustrates a process by which a set of VOD clip categories and optionally VOD clip parameters are selected and used to generate a composite VOD clip in accordance with one embodiment of the invention;

FIG. 2 illustrates the presentation and user selection of a number of VOD clip categories in accordance with one embodiment of the invention;

FIG. 3 illustrates the presentation and user selection of a number of VOD clip parameters in accordance with one embodiment of the invention;

FIGS. 4-6 illustrate exemplary selections of VOD clip parameters for corresponding VOD clip categories in accordance with various embodiments of the invention; and

FIG. 7 illustrates a system for generating and presenting a composite VOD clip in accordance with various embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the invention. Thus, the appearance of the phrases “in one embodiment” or “in an embodiment” in various places throughout the specification are not necessarily all referring to the same embodiment. Further more, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of the invention.

### Overview

Embodiments of the invention provide systems and methods for the automatic generation of a composite VOD content (i.e., a composite VOD clip) based upon user-selected VOD clip categories, and optionally, VOD clip characteristics. The composite VOD clip, which includes multiple component VOD clips sequenced together, may be presented as a passive viewing experience. Throughout this application the term “VOD clip” is defined to include any individually selectable VOD program or VOD stream; any chapter or segment within a single VOD program or stream; any defined pair of start-time and stop-time codes within a single VOD program or stream; and any program recorded to a DVR, or any accessible segment of such digital video recording.

Embodiments of the invention provide a system and method by which a user selects one or more categories and optional characteristics for VOD clips from a list or other selection presentation and a composite VOD content is then automatically generated that contains multiple VOD clips included in the selected categories or having the selected characteristics. Throughout this application, the term “user” describes any person (e.g., viewer, subscriber, etc.) using an embodiment of the invention in any form on any system.

The invention makes use of digital set top box (STB) capabilities, such as those described in related application Ser. No. 10/390,064, filed Mar. 14,2003, entitled System and Method For Construction, Delivery and Display of iTV, to deliver an interactive user interface application for defining and managing a subsequent passive video experience. In this application, “STB” and “television” (“TV”) may be used interchangeably, the term television being understood to provide STB-type capabilities. Embodiments of the invention thereby automatically create, and allow presentation of, a user-specific, passive viewing presentation. That is, once the VOD categories/characteristics have been selected and the composite VOD clip generated therefrom, no further interaction is required of the user during presentation of the VOD content.

One embodiment of the invention allows a user to select individual VOD clips as well as VOD clip categories, and optionally, VOD clip characteristics (parameters) to be used in the subsequent automatic generations of composite VOD clips.

For one embodiment of the invention, the availability of the small clips of content and the metadata associated with that content is used to provide personalized news and entertainment programs. For one embodiment of the invention, this is accomplished by allowing the user to select not only specific VOD clips, but to also select VOD clip categories and optionally other metadata attributes of VOD clips that the user would like to view.

### Process

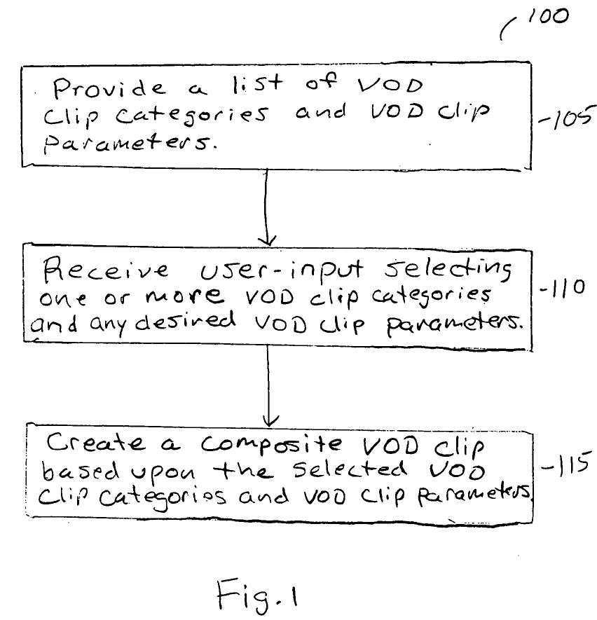

FIG. 1 illustrates a process by which a set of VOD clip categories and optional VOD clip parameters are selected and used to generate a composite VOD clip in accordance with one embodiment of the invention. Process 100, shown in FIG. 1, begins at operation 105 in which a list of VOD clip categories and VOD clip parameters is presented to the user to choose from.

At operation 110, the user selects desired VOD clip categories and may also select desired VOD clip parameters from among the list presented.

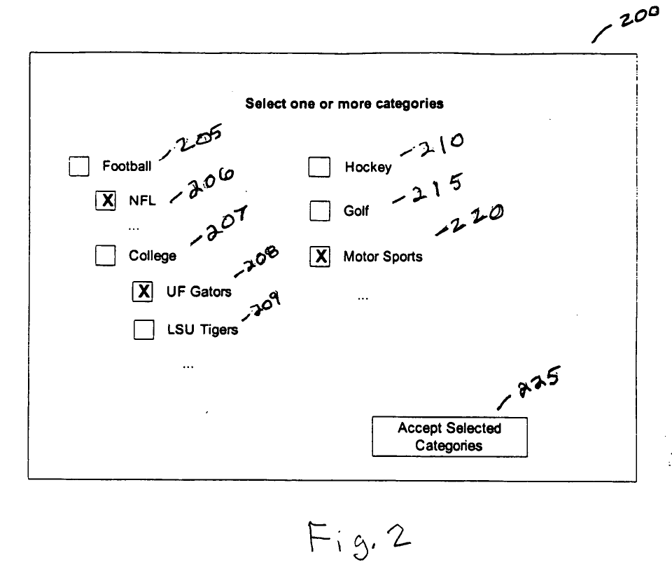

FIG. 2 illustrates the presentation and user selection of a number of VOD clip categories in accordance with one embodiment of the invention. As shown in FIG. 2, a VOD clip category selection presentation 200 is presented to the user. The VOD clip category selection presentation 200 includes a football category 205, a hockey category 210, a golf category 215, and a motor sports category 220. As shown in FIG. 2, various embodiments of the invention present the user with menus to select from a list of sub-categories within selected categories, which allows the user to specify a smaller set of VOD clips where a single VOD clip category may have too many VOD clips to be practically viewed as a composite VOD clip. For example, football category 205 is further divided in professional football category 206 (i.e., NFL© 2003, National Football League) and college football category 207, with college football category 207 being further divided in individual college football team categories 208 (i.e., UF Gators© 2003, University Athletic Association Inc.) and 209 (i.e., LSU Tigers© 2003, Louisiana State University). As indicated in FIG. 2, the user has selected VOD clip categories 206, 208, and 220. The VOD clip category selection presentation 200 also includes functionality 225 to finalize selection of the indicated VOD clip categories. These specific categories are exemplary in nature. In other embodiments of the invention, there may be any number of other categories that are displayed for selection by the user, as may be desired by the user for automatic generation of composite VOD clips.

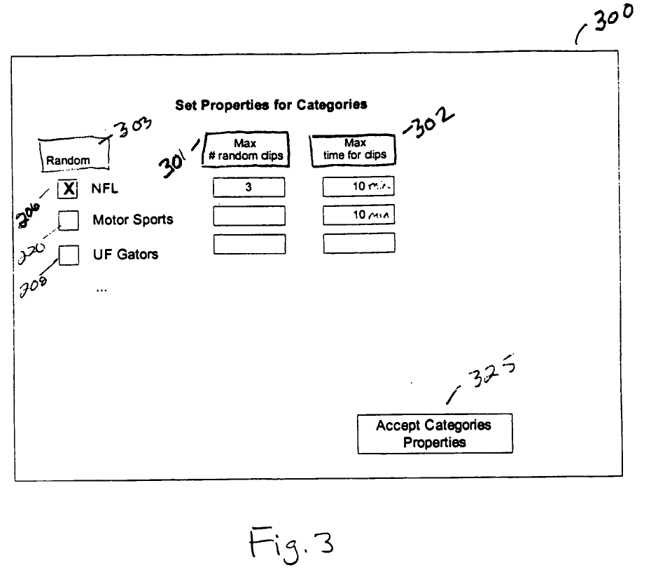

FIG. 3 illustrates the presentation and user selection of a number of VOD clip parameters in accordance with one embodiment of the invention. As shown in FIG. 3, a VOD clip parameter selection presentation 300 is presented to the user. The VOD clip parameter selection presentation 300 includes a maximum number parameter 301 and a maximum time parameter 302 and a random parameter 303. For each VOD clip category selected, a parameter may optionally be selected. For example, the maximum number parameter may be selected to set the number of VOD clips from each selected category while the maximum time parameter 302 may be selected to set the maximum length of time the total set of VOD clips for a given category (or set of categories) is allowed to consume in the final aggregate video stream (i.e., composite VOD clip). As shown in FIG. 3, various embodiments of the invention allow the user to select a “random” setting 303 to provide the random selections of VOD clips within a given VOD clip category (or across multiple categories). These specific parameters are exemplary in nature. In other embodiments of the invention, there may be any number of other parameter settings that are displayed for selection by the user, as may be appropriate for the categories being defined for automatic generation of composite VOD clips.

As indicated in FIG. 3, the user has selected a maximum number parameter 301 and a maximum time parameter 302 for VOD clip category 206 (i.e., NFL category) to show 3 random VOD clips with the sum of all 3 VOD clip lengths not to exceed 10 minutes. VOD clip category 208 (i.e., UF Gators) and VOD clip category 220 (i.e., Motor Sports) are directed to show all VOD clips with no random selection; however, VOD clip category 220 is directed not to contribute more than 10 minutes of content.

The VOD clip parameter selection presentation 300 also includes functionality 325 to finalize selection of the indicated VOD clip parameters for each VOD clip category.

In another embodiment of the invention, a “sequential” parameter (not shown) is offered in addition to, or instead of “random”. The “sequential” option causes the first N selected VOD clips of a given set of clips for a category to be selected.

Referring again to FIG. 1, at operation 115, upon direction from the user, a composite VOD clip is created from the currently available VOD content from the selected VOD categories constrained with any selected VOD clip parameters. Such available VOD content is referred to as component content of the composite VOD clip. The component content is presented as a composite VOD clip without further user-interaction, thus providing a passive viewing experience. Thus, a user is able to specify VOD clip categories, and optionally, VOD clip parameters to effect the creation of a composite VOD clip. For example, a user may tune to an interactive sports channel. From that interactive channel the user is presented with a VOD clip category selection presentation that includes the mechanisms for selecting desired categories. For example, the user may select the categories of “UF Gators Football”, “Baseball”, “Motor Sports”, and “Hockey”. For one embodiment of the invention, the category selections are recorded such that when the user elects to view a composite VOD clip based upon the selected categories, the user will be presented with a stream of video (and its associated audio) that includes the currently available content for each of the selected categories.

For one embodiment of the invention, the VOD content that the user has already viewed is noted, and the user may elect to view only content that is new (i.e., as of the previous composite VOD creation) or as yet unviewed by the particular user.

For one embodiment of the invention, a system operator and/or VOD content provider may insert VOD clips between any of the VOD clips resulting from the user's category selection. Such inserted VOD clips may include promotional clips such as advertising or promotions of other VOD content (e.g. VOD content outside of the user's selected categories, or subsequent VOD content within the user's selected categories to encourage continued viewing).

For one embodiment of the invention, such inserted VOD clips may be personalized to the specific user and based upon the user's category selections, or other information specific to the user.

For one embodiment of the invention, the automatic composite VOD clip generator may insert graphical and textual data content along with the VOD clips, such as tickers and ads and promotional materials alongside or overlaying a portion of the video.

In another embodiment of this invention, the user is then further allowed to specify additional properties such as “do not repeat clips”. The “do not repeat clips” option may be set against each category or against an entire set of clips and will allow the user to watch the same personalized program again without repeating any video clips. This is further illustrated where a user has elected to see only three sequential clips from a given category and has elected to not repeat clips. Now, each time the user watches the personalized program for which he/she has input this data, the user will see at most only three clips and will only see clips that he/she has not viewed previously. As new clips are made available for the given categories, they will be added to the list of available clips and marked as not-yet-viewed.

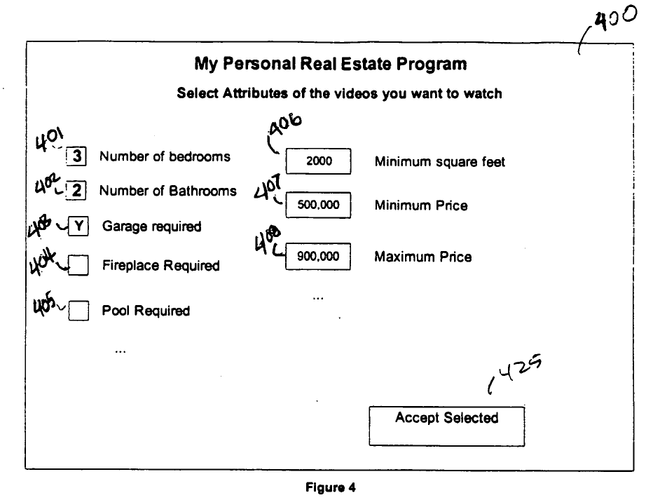

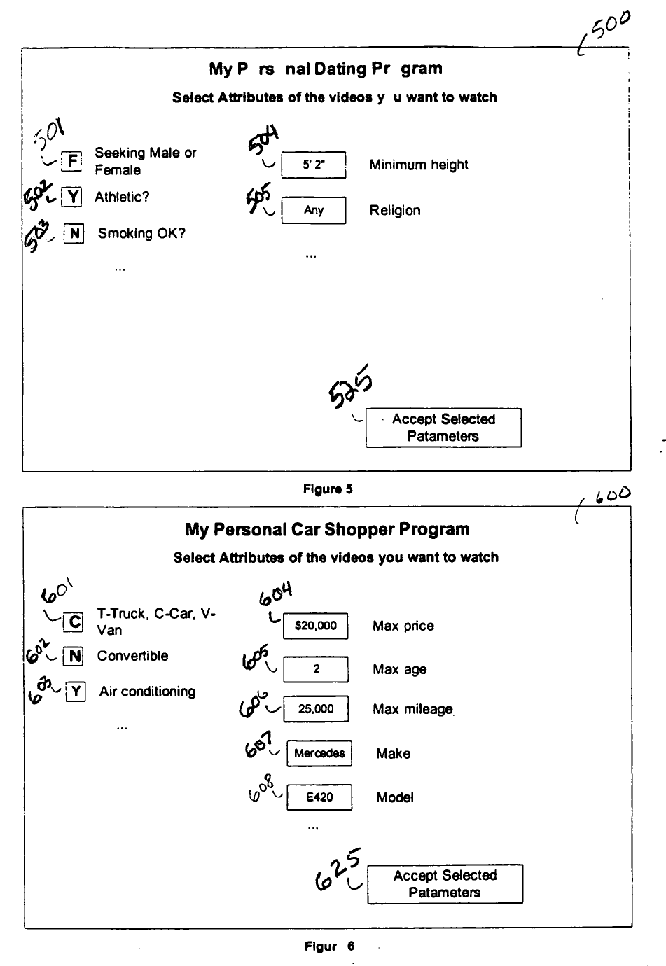

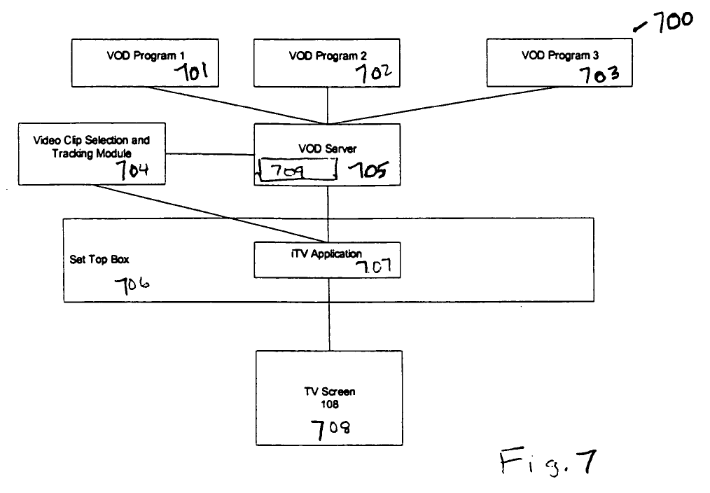

Further illustrations of the processes for selecting clips are given in FIG. 4, FIG. 5, and FIG. 6, which illustrate exemplary selections of VOD clip parameters for corresponding VOD clip categories in accordance with various embodiments of the invention. Categories and parameters can be implemented by providing sets of selectable parameters to define specific attributes of the set of selected VOD clips to be used to create the composite VOD clip to effect a personalized program and passive viewing experience.

FIG. 4 illustrates a personalized VOD program (e.g., personalized Real Estate program) 400 through which the user is presented with parameters 401-408 corresponding to the VOD program 400. The user selects parameters to create a composite VOD clip containing relevant real estate information. The personalized VOD program 400 also includes functionality 425 to finalize selection of the VOD clip parameters.

FIG. 5 illustrates a personalized VOD program (e.g., personalized Dating Program) 500 through which the user is presented with parameters 501-505 corresponding to the VOD program 500. The user selects parameters to create a composite VOD clip containing relevant dating information. The personalized VOD program 500 also includes functionality 525 to finalize selection of the VOD clip parameters.

FIG. 6 illustrates a personalized VOD program (e.g., personalized Car Shopper Program) 600 through which the user is presented with parameters 601-608 corresponding to the VOD program 600. The user selects parameters to create a composite VOD clip containing relevant car shopping information. The personalized VOD program 600 also includes functionality 625 to finalize selection of the VOD clip parameters.

As described above in reference to FIGS. 4-6, alternative embodiments of the invention provide for gathering of such data and then using that data to select a list of VOD clips, which are used to create a composite VOD clip presented as a single program. When the personalized program (i.e., composite VOD clip) is presented, the user will only see VOD content relevant to the selected VOD clip parameters.

### System

FIG. 7 illustrates a system for presenting a composite VOD in accordance with various embodiments of the invention. System 700, shown in FIG. 7, includes an iTV Application 707 in the client STB 706 which is presented to the user via TV screen 708. VOD Server 705 is coupled to VOD programs 701, 702, and 703. System 700 includes a Video Clip Selection and Tracking Module (VCSTM) 704. The VCSTM 704 is implemented on the VOD Server 705. In an alternative embodiment of the invention the VCSTM 704 is implemented on the STB 706. In another alternative embodiment of this invention the VCSTM 704 is implemented via a combination of client and server components.

The VCSTM takes a request from the iTV Application 707 to present a personalized program from a given program provider. Prior to presentation, the user will have selected desired VOD clip categories, and optionally, VOD clip parameters via this, or another iTV application. Note that the input mechanism for selection of VOD clip categories and VOD clip parameters may be any computer-aided means. The result of any such input is either storage within the User Category Selection and Settings Storage 709, or stacked up as dynamic parameters feeding the VCSTM request to present a personalized program.

For one embodiment of the invention, the VOD clip categories and VOD clip parameters may be selected via a PC-based web interface. Regardless of the selection mechanism, once the VCSTM 704 receives a request to present a personalized program it will look at the User Category Selection and Settings Storage 709 (or review the dynamic parameters on the request received by the VCSTM) to determine what categories or video classifications are of interest to the user. The collection of categories may also span multiple providers where the personalized program is offered from a content aggregation point such as the system operator.

Once the relevant categories and providers are established then the VCSTM 704 will interrogate the VOD server 705 (or some intermediary) to determine what VOD clips are currently available. The VCSTM 704 applies any VOD clip category selections to the available VOD clips to come up with a final set of clips. Application of settings includes items such as selecting a subset of VOD clips from the list of all available VOD clips where a setting for number of VOD clips or total duration is exceeded by the total list of VOD clips for a given category. The application of the settings may also include selecting VOD clips that have not been viewed previously. In such an embodiment, the VOD clips that have been previously presented to the user will be noted in the User Category Selections and Settings Storage 709.

In order to track the VOD clip views, the iTV Application 707 will inform the VCSTM 704 that a specific VOD clip ID has been viewed such that the VCSTM 704 can then write the data to the User Category Selections and Setting Storage 709 keyed by the specific user to which the particular VOD clip has been presented.

### General Matters

Embodiments of the invention provide systems and methods for selecting a number of VOD clip categories and corresponding VOD clip parameters and creating and presenting a composite VOD clip, based thereon, without further user interaction. Although embodiments of the invention have been described in the context of a digital television system, alternative embodiments may be used in other systems. For example, an embodiment of the invention may be utilized over a satellite TV system where some technology, such as broadband, is used to deliver On Demand or pre-cached programs. Another example of a non-cable system to which an embodiment of the invention is applicable, is a gaming device (e.g., XBOX, PlayStation, GameCube, PC, etc.) attached to a television or monitor where said device has a broadband connection with the ability to deliver On Demand and/or pre-cached programs.

The invention has many applications. Some applications, by way of example only, include but are not limited to, creating personalized news and entertainment programs that restrict content and duration based upon user specifications.

Embodiments of the invention include various operations. Many of the methods are described in their most basic form, but operations can be added to or deleted from any of the methods without departing from the basic scope of the invention.

It will be apparent to those skilled in the art that the operations of embodiments of the invention may be stored upon or embodied in machine-executable instructions, which may be used to cause a general-purpose or special-purpose processor or logic circuits programmed with the instructions to perform specific operations.

Alternatively, the operations of embodiments of the invention may be performed by a combination of hardware and software. Embodiments of the invention present may be provided as a computer program product that may include a machine-readable medium having stored thereon instructions, which may be used to program a computer (or other electronic devices) to perform a process according to various embodiments of the invention.

Such machine-readable medium may include, but are not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote processor to a requesting processor by way of data signals embodied in a carrier wave or other propagation medium via a communication cell (e.g., a modem or network connection). The present invention also relates to an apparatus for performing the operations herein. This apparatus may be specially constructed for the required purposes, or it may comprise a general-purpose processing system selectively activated or reconfigured by an application program stored within the processing system. Such an application program may be stored in a machine-readable storage medium, such as, but is not limited to, any type of disk including floppy disks, hard disks, optical disks, CD-ROMs, and magneto-optical disks, read-only memories (ROMs), random access memories (RAMs), EPROMs, EEPROMs, magnetic or optical cards, or any type of media suitable for storing electronic instructions, and each coupled to a computer system bus.

The processes described herein are not inherently related to any particular system or other apparatus. Various general-purpose systems may be used with programs in accordance with the teachings herein, or it may prove convenient to construct a more specialized apparatus to perform the described operations.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
providing a list or lists of one or more video-on-demand (VOD) clip categories, each VOD clip category containing one or more corresponding VOD clips;
receiving user input, the user input specifying at least one VOD clip category; and
automatically creating a composite VOD clip based upon the specified at least one VOD clip category wherein the composite VOD clip consists of each of the one or more corresponding VOD clips of each specified VOD clip category.

2. The method of claim 1 further comprising:
presenting the composite VOD clip to a user to effect a passive viewing experience.

3. The method of claim 2 further comprising:
providing a list of one or more VOD clip parameters, each of the VOD clip parameters pertaining to a subset of the one or more VOD clips corresponding to a VOD clip category.

4. The method of claim 3 further comprising:
receiving further user input, the further user input specifying at least one of the one or more VOD clip parameters, wherein the composite VOD clip consists of the subset of the one or more VOD clips corresponding to the selected VOD clip parameters in each specified VOD clip category.

5. The method of claim 4 wherein the one or more VOD clip parameters includes a VOD clip parameter selected from the group consisting of a random selection parameter, a maximum number parameter, a maximum time parameter, and a sequential parameter.

6. The method of claim 1 wherein the composite VOD clip is automatically regenerated upon user request or according to an externally specified schedule.

7. The method of claim 1 wherein any component VOD clips made available prior to a specified time are removed from the composite VOD clip.

8. The method of claim 1 wherein any component VOD clips previously presented to a particular user are removed from the user's composite VOD clip.

9. The method of claim 1 wherein one or more additional VOD clips are included as component VOD clips of the composite VOD clip.

10. The method of claim 1 wherein the one or more additional VOD clips is a VOD clip selected from the group consisting of advertising VOD clips, promotional VOD clips pertaining to VOD content unrelated to the composite VOD clip, and promotional VOD clips pertaining to VOD content related to the composite VOD clip.

11. The method of claim 1 wherein one or more additional graphical or data contents, including content tickers, graphical ads or promotional contents unrelated to the composite VOD clip, and content tickers, graphical ads or promotional contents related to the composite VOD clip, are added alongside or partially overlay the composite VOD clip.

12. A machine-readable medium having stored thereon executable instructions which when executed by a processor cause a method to be performed, the method comprising:
providing a list or lists of one or more video-on-demand (VOD) clip categories, each VOD clip category containing one or more corresponding VOD clips;
receiving user input, the user input specifying at least one VOD clip category; and
automatically creating a composite VOD clip based upon the specified at least one VOD clip category wherein the composite VOD clip consists of each of the one or more corresponding VOD clips of each specified VOD clip category.

13. The machine-readable medium of claim 12, the method further comprising:
presenting the composite VOD clip to a user to effect a passive viewing experience.

14. The machine-readable medium of claim 13, the method further comprising:
providing a list of one or more VOD clip parameters, each of the VOD clip parameters pertaining to a subset of the one or more VOD clips corresponding to a VOD clip category.

15. The machine-readable medium of claim 14, the method further comprising:
receiving further user input, the further user input specifying at least one of the one or more VOD clip parameters, wherein the composite VOD clip consists of the subset of the one or more VOD clips corresponding to each specified VOD clip category.

16. The machine-readable medium of claim 15 wherein the one or more VOD clip parameters includes a VOD clip parameter selected from the group consisting of a random selection parameter, a maximum number parameter, a maximum time parameter, and a sequential parameter.

17. The machine-readable medium of claim 12 wherein the composite VOD clip is automatically regenerated upon user request or according to an externally specified schedule.

18. The machine-readable medium of claim 12 wherein any component VOD clips made available prior to a specified time are removed from the composite VOD clip.

19. The machine-readable medium of claim 12 wherein any component VOD clips previously presented to a particular user are removed from the composite VOD clip.

20. The machine-readable medium of claim 12 wherein one or more additional VOD clips are included as component VOD clips of the composite VOD clip.

21. The machine-readable medium of claim 12 wherein the one or more additional VOD clips is a VOD clip selected from the group consisting of advertising VOD clips, promotional VOD clips pertaining to VOD content unrelated to the composite VOD clip, and promotional VOD clips pertaining to VOD content related to the composite VOD clip.

22. A system comprising:
a server storing VOD content, the VOD content including a plurality of VOD clip categories, each VOD clip category containing one or more corresponding VOD clips; and
a set top box coupled to the server, the set top box storing an application, the application including a VOD clip category selection functionality, that enables a user to access the plurality of VOD clip categories and select one or more VOD clip categories, and a VOD clip composite functionality that automatically creates a composite VOD clip wherein the composite VOD clip consists of each of the one or more corresponding VOD clips of each selected VOD clip category.

23. The system of claim 22 further comprising:
a display screen for presenting the composite VOD clip to the user to effect a passive viewing experience.

24. The system of claim 23 wherein application further includes a VOD clip parameter selection functionality that allows a user to select one or more VOD clip parameters, each of the VOD clip parameters pertaining to a subset of the one or more VOD clips corresponding to a VOD clip category such that the created composite VOD clip consists of the subset of the one or more VOD clips corresponding to each selected VOD clip category.

25. The system of claim 24 wherein the one or more VOD clip parameters includes a VOD clip parameter selected from the group consisting of a random selection parameter, a maximum number parameter, a maximum time parameter, and a sequential parameter.

26. The system of claim 22 wherein the composite VOD clip is automatically regenerated upon user request or according to an externally specified schedule.

27. The system of claim 22 wherein any component VOD clips made available prior to a specified time are removed from the composite VOD clip.

28. The system of claim 22 wherein any component VOD clips previously presented to a particular user are removed from the composite VOD clip.

29. The system of claim 22 wherein one or more additional VOD clips are included as component VOD clips of the composite VOD clip.

30. The system of claim 22 wherein the one or more additional VOD clips is a VOD clip selected from the group consisting of advertising VOD clips, promotional VOD clips pertaining to VOD content unrelated to the composite VOD clip, and promotional VOD clips pertaining to VOD content related to the composite VOD clip.
